(19) United States
(12) Patent Application Publication
(10) Pub. No.: US 2025/0173038 A1
(43) Pub. Date: May 29, 2025

(54) Guide for Aligning Two Immersive Reality System Controllers

(71) Applicant: ORANGE, Issy-Les-Moulineaux (FR)

(72) Inventors: Maxime Jouin, Chatillon Cedex (FR); Jérémy Lacoche, Chatillon Cedex (FR); Valérie Ledunois, Chatillon Cedex (FR)

(21) Appl. No.: 18/956,185

(22) Filed: Nov. 22, 2024

(30) Foreign Application Priority Data
Nov. 28, 2023 (FR) 2313187

(51) Int. Cl. G06F 3/04815

(52) U.S. Cl. CPC G06F 3/04815

(57) ABSTRACT

A physical guide for aligning a first controller of a first immersive reality system, with a second controller of a second immersive reality system, possibly by engaging with a second guide for aligning this second controller. Such an implementation serves to determine a reference frame common to a virtual spaced of the first system and a virtual space of the second system.

### CROSS-REFERENCE TO RELATED APPLICATION

This application claims priority to French Patent Application No. FR2313187, filed Nov. 28, 2023, the entire contents of which are incorporated herein by reference.

### FIELD OF THE INVENTION

The present disclosure relates to the field of data processing in immersive reality (virtual or augmented).

### DESCRIPTION OF RELATED ART

When several users use individual immersive reality (generic term for extended reality XR, augmented reality AR, virtual reality VR, mixed reality RM, etc.) devices, such as immersive reality headsets, at the same time in the same real space, the various users may perceive a virtual object (sound, visual, etc.) in distinct positions of the shared real space because these immersive reality devices are not spatially synchronized (calibrated).

In fact, each user is located in their own space via the headset which they use (for example, according to a technique called “tracking inside out”).

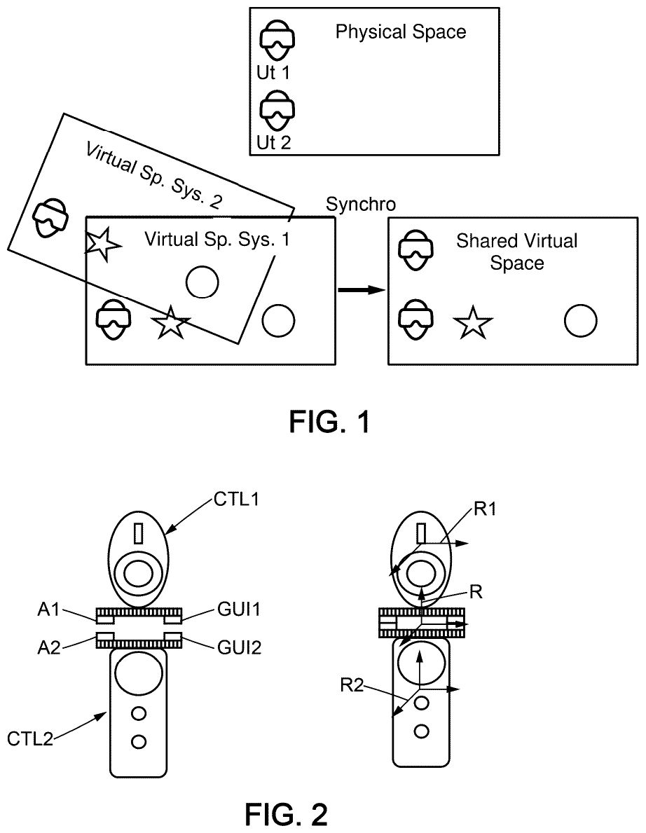

When several users share the same physical and virtual space, in order to live the same experience, it is then appropriate to synchronize (calibrate) these spaces so that each user uses a single spatial coordinate system. Without such synchronization, the users do not perceive the virtual elements in the same area of the space, for example. Such a situation is shown on the left in FIG. 1.

In the state of the art, there are several solutions for alleviating this problem.

A first solution proposes that the headsets used rely on an algorithm called “SLAM”: it is possible to share a map (for example a cloud of points) between the various equipment and, with that, a single coordinate system by resetting. In practice, the manufacturers do not always allow this map sharing and this SLAM method does not typically work for synchronizing headsets from different manufacturers.

A second solution proposes headsets equipped with cameras for calibration relative to an identified element in the real environment, for example, a QR code. Since the placement (position/rotation) of the QR code is then known in the space of each headset, it is possible to align all the spaces. In practice, not all manufacturers give access to the cameras in the headset for implementing this detection. This second method also requires the users to position this element in their space.

The third method, conventionally used, may rely on controllers for these devices. Each user successively positions their controller (referenced in 3D space) at a position in the room (for example on a base) and presses a button. The immersive reality system thus knows the position of this base in the reference frame of each headset and may therefore align the spaces. The third method is relatively slow, difficult to use for controllers from different manufacturers and may lack precision if the controller is not well positioned on its base.

Thus, according to the third solution in particular, when the individual immersive reality devices are equipped with interaction controllers, detecting the position of a controller of each user in the shared real space placed in a preset position of the shared real space (for example on a base specific to each controller) is proposed. The disadvantage of this solution rests in particular in the lack of precision of the alignment of the virtual spaces of each user of the shared real space, for immersive reality devices and in particular for controllers from different manufacturers. In fact, two controllers from different manufacturers are difficult to position at a precise position of the shared real space.

### BRIEF SUMMARY OF THE INVENTION

The present disclosure aims to improve the situation.

For this purpose, it proposes a calibration of immersive user spaces by aligning the controllers.

More specifically it targets a physical guide for aligning a first controller for a first immersive reality system, with a second controller for a second immersive reality system, for determining a reference frame common to a virtual space of the first system and a virtual space of the second system.

The aforementioned first and second immersive reality systems may respectively comprise the first and second controllers, and typically also an immersive reality headset, each, as indicated above.

Thus, with this physical guide, it is possible to align the settings of the two immersive reality systems and share a single reference frame in a virtual space.

In an implementation, the guide may be configured for:
being affixed to one of the first and second controllers; and
being in a preset position relative to another physical guide which is affixed to the other of the first and second controllers, for aligning the first and second controllers.

In this case, it is thus possible to provide a guide specific to each controller, and to then align the two guides for sharing a common reference frame.

In one implementation, affixing the guide to said “one of the first and second controllers” may be done by mechanically securing.

For example, the guide may be integrated with a protective case housing in fixed position said “one of the first and second controllers.”

In particular, it may be provided that each physical guide comprises at least one alignment contact able to engage with the alignment contact of the other physical guide.

Such an alignment contact may be a Velcro strip for example, or a pair of magnets or of notches of engaging shapes.

These alignment contacts for the guides may typically comprise a device for temporary attachment of the two guides with fool proofing of the relative positions of the two guides.

In fact, the attachment may take place pointwise during the calibration of the shared virtual space (for spatial synchronization of the individual virtual spaces of the two immersive reality devices).

Further, “fool proofing” is understood to mean the action of using one or more physical devices, in particular mechanical, for avoiding an error, in particular assembly, mounting, plugging or other errors. Such an implementation then serves to provide a good translational, but also rotational, positioning of one guide relative to the other.

For example, each guide may comprise two alignment contacts able to engage with two alignment contacts of the other physical guide, and for example these two alignment contacts may comprise two magnets with reversed respective polarities.

In an implementation, the guide may further comprise a transmitter of a signal for aligning the first and second controllers, where this transmitter is:
active when the first and second controllers are aligned, for triggering a calibration of the virtual spaces of the first and second immersive reality systems, and thus determining the aforementioned common reference frame;
and otherwise inactive.

In an implementation, the respective alignment contacts of the first and second controllers are conductors and able to transmit, by electrical conduction, this signal for aligning the first and second controllers when the first and second controllers are aligned, where receiving this alignment signal by one of the first and second controllers may trigger the aforementioned calibration of the virtual spaces.

Typically, this signal may be electrical, capacitive or other.

Alternatively, this signal may be an optical signal and it may be provided that the transmitter comprises a through hole configured for:
letting an optical ray pass from one controller, transmitting, to the other controller, receiving, when the first and second controllers are aligned; or
otherwise stopping the optical ray, where detection of the optical ray by a sensor of the receiving controller triggers said calibration of the virtual spaces when the first and second controllers are aligned.

According to another aspect, the present application also targets a controller for an immersive reality system, comprising a physical guide for aligning the controller with another controller from another immersive reality system, for determining a common reference frame between respective virtual spaces of these immersive reality systems.

This controller may typically be an interaction controller (possibly pre-existing) for an immersive reality system.

In an implementation of this controller, the physical guide may be configured for being placed in a preset position relative to another physical guide of another controller.

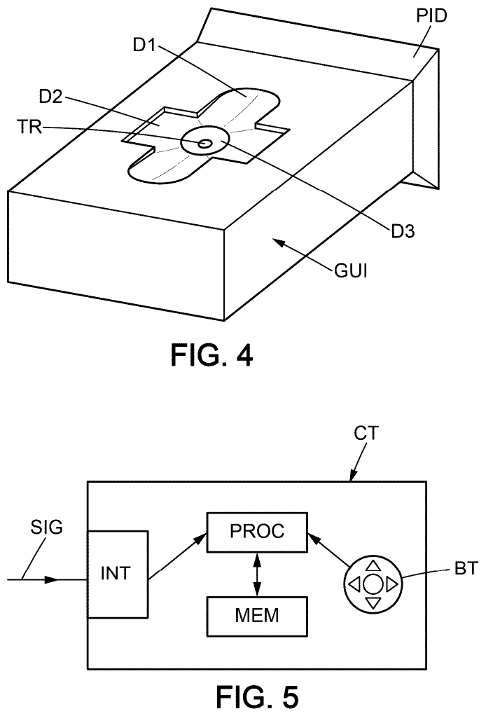

An input interface activatable by a user may further be provided for triggering, when the two controllers are aligned, a calibration of the virtual spaces of the first and second immersive reality systems and determining the aforementioned common reference frame. This input interface may for example be a button on which a user presses when the two guides (or the two controllers) are placed in the respective alignment positions (or respectively relative to a single guide, as described later with reference to FIG. 4).

According to another aspect, the present description also targets a method for calibration of a first immersive reality system with a second immersive reality system, where the first system comprises a first controller and a physical guide for aligning the first controller with a second controller that the second immersive reality system comprises, where the method comprises:
determining a common reference frame between a virtual space of the first system and a virtual space of the second system upon detection by the first controller of an alignment signal with the second controller; and
obtaining at least one coordinate transformation matrix from the first virtual space into said common reference frame.

This coordinate transformation matrix serves to switch from a virtual space specific to a given system, to a space shared with the other system and typically having a single common reference frame.

For this purpose, getting “at least one” transformation matrix is provided, because each controller may have its own specific transformation matrix from its own space into the shared space. Alternatively, a single transformation matrix may be provided (for an adaptation from one system to the space of the other system).

According to another aspect, a computer program is proposed comprising instructions for implementing all or part of a method such as defined in the present when this program is executed by a processor. According to another aspect a nonvolatile, computer-readable recording medium is proposed on which such a program is recorded.

### BRIEF DESCRIPTION OF THE DRAWINGS

Other characteristics, details and advantages will appear upon reading the following detailed description, and analyzing the attached drawings, on which:

### FIG. 1

FIG. 1 shows a calibration of two immersive reality systems.

### FIG. 2

FIG. 2 shows a possible embodiment using two respective guides for controllers of immersive reality systems, for aligning the two controllers.

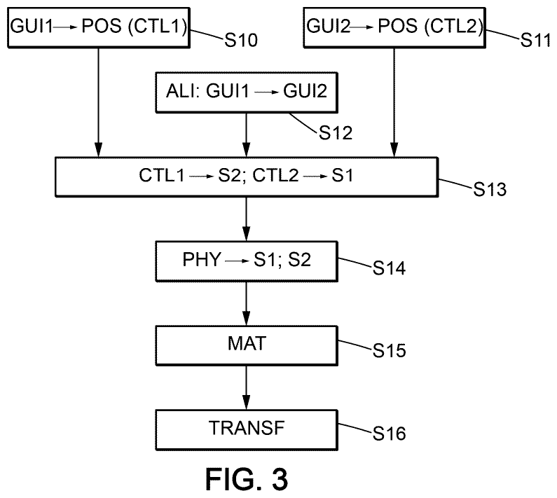

### FIG. 3

FIG. 3 shows an example of a succession of steps for a method implemented by the controllers from FIG. 2.

### FIG. 4

FIG. 4 shows an example of a guide for aligning two respective immersive reality system controllers.

### FIG. 5

FIG. 5 shows schematically the processing circuit for an immersive reality system controller.

### DETAILED DESCRIPTION OF ILLUSTRATIVE EMBODIMENTS

To resolve the problem of positioning precision in real space, providing controllers with a physical alignment guide is proposed. Each physical alignment guide can be placed in a preset position relative to another physical alignment guide. The alignment reference mark for the virtual space shared by the two individual immersive reality devices for which the controllers are aligned is then placed between the two physical alignment guides.

It is thus proposed to rely on the controllers of the users who are located in the 3D space (by position and rotation) of each user, and in particular to equip them with a physical guide for aligning the two controllers. The physical guide may be mechanically integrated in the controller, or even a case (such as an envelope protecting the controller against shocks, for example). Again alternatively, the physical guide may comprise reference marks for positioning its controller, which allows one user to place the controller at a precise point of the guide, for example using visual reference marks or by positioning the controller against a mechanical notch specific to the controller model.

More specifically, each user successively synchronizes their space with the space of the other user by bringing their controller close to that of the other user and aligning them by a mechanical engagement of the two respective guides of the controllers. This alignment is done using a physical guide positioned on the controller as shown in FIG. 2. Aligning the two controllers may be made easier by the presence of magnets which may thus guarantee that the two controllers are correctly positioned relative to each other. Alternatively, the magnets may be replaced by pairs of counterpart projections/housings arranged respectively on the guides to provide a foolproof by mechanical engagement, or by any other temporary mechanical securing like a Velcro® strip or other.

Referring to the part on the left of FIG. 2, a first controller CTL1 of the first immersive reality system (typically connected to a headset of the system) is typically affixed to a first alignment guide GUI1, for example by being mechanically secured to the first controller CTL1. Correspondingly, a second controller CTL2 from the second system is affixed here to a second alignment guide GUI2. Each guide GUI1 comprises at least one alignment contact A1 for aligning with an alignment contact A2 for the other guide GUI2. In FIG. 2, two alignment contacts are shown for each guide, for example a pair of inversely polarized magnets, which allows both:
precisely positioning the first guide GUI1 against the second guide GUI2; and
foolproofing this positioning for a user handling the two controllers CTL1 and CTL2 and their respective guides GUI1 and GUI2.

Now referring to the part on the right of FIG. 2, the first controller CTL1 may precisely determine the position of the first guide GUI1 in a first reference frame R1 of the virtual space thereof, and the second controller CTL2 may determine precisely the position of the second guide GUI2 in a second reference frame R2 of the virtual space thereof. When the two guides GUI1 and GUI2 are perfectly aligned (for example by detection of a signal (electrical or optical as described above) for alignment of the two guides), it is then possible to determine a reference frame R, common to the two virtual spaces of the first and second immersive reality systems.

To confirm the alignment, it is possible to further ask the users to press on a button of the controller. It is also possible to automatically detect the contact using a sensor (optical, electrical or pressure) placed on the guide, generating communication of a signal confirming alignment of the two controllers. For example, the circulation of a very weak electrical current between the two controllers via the conducting magnets A1-A2 may be detected by each controller at the moment of contact via the magnets and when the two guides are aligned. For example, in a variant, one of the controllers CTL1 may generate this current and the other controller CTL2 may receive it via the magnets A1-A2 and detect this weak electric current. For example, it may involve detecting a “capacitive” contact between the magnets A1-A2 (very weak current detected).

Alternatively, a window for optical emission of a light ray on one controller may be aligned with a window housing an optical sensor on the other controller, for detecting the ray and thus determining that there is alignment.

The position of the physical guide may be determined in advance in the coordinate reference frame of the controller on which it is positioned. This step uses a manual calibration per headset model. It may be done once for all when the guide is permanently secured to the controller (in factory or by a user who encloses the controller with a protective case). It is possible to adapt the guide to controllers from various manufacturers in order to determine the calibration of different equipment.

In an implementation variant from FIG. 2, shown in FIG. 4, a single guide GUI may be used for aligning the respective controllers of two distinct systems. In the example shown, two opposite surfaces of the guide GUI may comprise surface depressions D1, D2, D3 (by machining or embossing metal surfaces for example). These depressions match the shape of various controller models (for example here three different controller models, or at least three different controller model shapes). Thus, controller ends with different shapes may be positioned in each of the opposite surfaces of the guide, where the guide may comprise a foot PID to place on a horizontal surface mechanically stabilizing the positioning of one controller relative to the other. The guide may then comprise a through hole TR for allowing, for example, a light ray to optically propagate from one controller end to the end of the other controller, when the two controllers are affixed to both sides of the guide.

Updating the coordinate system may then be done as follows, referring to FIG. 3.

The following is known in advance:
The positions of the physical guides in the respective reference frames of each controller at steps S10 and S11; and
The relative positions of the two physical guides when they are aligned in step S12.

After aligning, one may further know in step S13:
The position of the controller for the first headset in the reference frame of the second headset; and
The position of the controller for the second headset in the reference frame of the first headset.

From this is deduced:
The position of a single physical reference mark, common to the space of each user in step S14; and
The transformation matrix MAT between the position of the controller CTL1 for the first headset and the position of the controller CTL2 for the second headset, in step S15.

This transformation matrix then serves to transform the coordinate system of one of the two headsets so that the two coordinate systems coincide for the remainder of the immersive experience, for any following step S16 as can be seen in the right of FIG. 1.

As an alternative to the determination of a single matrix in step S15, two matrices may be determined in steps S13 and S14, where each matrix is specific to a common reference frame in the spaces of two headsets. In this case, each headset system must correct the coordinates thereof by means of its own matrix, which may call on resources for the two headset systems (instead of only demanding resources of one single system in the embodiment from FIG. 3).

FIG. 5 shows a sample implementation of a controller comprising a processing circuit CT comprising:
memory MEM that can in particular store instruction data for a computer program for implementing a method in the meaning of the present description (for example the method shown in FIG. 3);
an interface INT that can receive the aforementioned signal (SIG), for aligning the two controllers;
a processor PROC accessing said interface INT and said memory for reading and executing the instructions of the program once an alignment with another controller is detected, for example;
possibly a button BT available to a user for initiating the method for aligning the controller shown with another controller.

Of course, the aforementioned processing circuit may further comprise a communication interface with the other controller, for example, to receive the positions thereof (step S11 in FIG. 3) in order in particular to estimate the aforementioned transformation matrix. In this respect, the aforementioned computer program may comprise instructions distributed between the aforementioned first and second controllers for cooperating with each other.

### INDUSTRIAL APPLICABILITY

The subject matter of the present description may make it easier to create and deploy immersive reality (virtual and/or augmented) applications with several users sharing the same physical space. It is then possible to make headsets from different brands cooperate in the same space, to rapidly calibrate different headsets before starting a real-time application, to correct tracking drift, etc., and to do so by a simple action for the users. Typically in the entertainment field, immersive reality (virtual reality) arcade halls which offer immersion of several users in a single physical space may welcome users equipped with their own headset, even though these headsets could be made by different manufacturers.

In augmented reality, some headsets (Magic Leap® for example) can find their location in the reference frame of the building by means of their cameras, but that is not the case for a headset like Quest Pro® because the cameras are not accessible to the developers. With this implementation, by bringing the controllers for the two peripherals together, the Quest Pro® may be located in the same space of the building as the Magic Leap®. There are multiple application cases (in connected home (or “Smart Home”), and Industry 4.0 or even in Smart City).

The present disclosure is not limited to the implementation examples presented above, but it encompasses other invariants. For example, in the embodiment from FIG. 3, an example was shown in which two controllers synchronize with each other. Of course, more than one controller may be synchronized with a “master” controller; the steps from FIG. 3 are repeated for each “slave” controller needing to synchronize with a “master” controller (which may be a slave to another master controller). Each system with a “slave” controller then has its own transformation matrix for sharing a reference frame common to all the spaces of the headset systems.

What is claimed is:

1. A physical guide comprising:
at least one alignment feature which is configured to align a first controller of a first immersive reality system, with a second controller of a second immersive reality system, to define a reference frame common to a virtual space of the first system and a virtual space of the second system.

2. The physical guide according to claim 1, configured to:
be affixed to one of the first and second controllers; and
be in a preset position relative to another physical guide which is affixed to the other of the first and second controllers, for aligning the first and second controllers.

3. The physical guide according to claim 2, wherein the alignment feature comprises a mechanical engagement to secure to said one of the first and second controllers.

4. The physical guide according to claim 3, wherein the guide is integrated with a protective case housing in a fixed position to said one of the first and second controllers.

5. The guide according to claim 2, the alignment feature comprising at least one alignment contact configured to engage with an alignment contact of the other physical guide.

6. The physical guide according to claim 5, wherein the at least one alignment contact comprises a device for temporary attachment of to the other physical guide with fool proofing of relative positions of the.

7. The physical guide according to claim 5, wherein the alignment feature comprises first and second alignment contacts configured to engage with respective first and second alignment contacts of the other physical guide, and wherein the first and second alignment contacts comprise of the physical guide comprise first and second magnets, respectively, with reversed respective polarities.

8. The physical guide according to claim 1, further comprising:
a transmitter of a signal for aligning the first and second controllers, where said transmitter comprises:
an active state when the first and second controllers are aligned, for triggering a calibration of the virtual spaces of the first and second immersive reality systems, and determining said common reference frame;
and an otherwise inactive state.

9. The physical guide according to claim 5, further comprising a transmitter of a signal for aligning the first and second controllers, where said transmitter comprises:
an active state when the first and second controllers are aligned, for triggering a calibration of the virtual spaces of the first and second immersive reality systems, and determining said common reference frame;
and an otherwise inactive state,
and wherein, the respective alignment contacts of the first and second controllers are conductors and able to transmit, by electrical conduction, said signal for aligning the first and second controllers when the first and second controllers are aligned, a receiving of said alignment signal by one of the first and second controllers triggering said calibration of the virtual spaces.

10. The physical guide according to claim 8, wherein the transmitter comprises a through hole configured to:
let an optical ray pass from one controller, transmitting, to the other controller, receiving, when the first and second controllers are aligned; or
otherwise stopping the optical ray,
a detection of the optical ray by a sensor of the receiving controller triggering said calibration of the virtual spaces when the first and second controllers are aligned.

11. A controller for an immersive reality system, comprising:
a physical guide comprising an alignment feature which is configured to align the controller with another controller of another immersive reality system, for determining a common reference frame between respective virtual spaces of said immersive reality systems.

12. The controller according to claim 11, wherein, the alignment feature enables the physical guide to be placed in a preset position relative to another physical guide of the other controller.

13. The controller according to claim 11, further comprising an input interface activatable by a user for triggering, when the controller and the other controller are aligned, a calibration of the virtual spaces of the first and second immersive reality systems and determining said common reference frame.

14. A method comprising:
calibrating a first immersive reality system with a second immersive reality system, the first system comprising a first controller and a physical guide for aligning the first controller with a second controller of second immersive reality system, the calibrating comprising:
upon detection by the first controller of an alignment signal with the second controller, determining a common reference frame between a virtual space of the first immersive reality system and a virtual space of the second immersive reality system; and
obtaining at least one coordinate transformation matrix from the first virtual space into said common reference frame.

15. A non-transitory computer readable storage medium storing instructions of a computer program which when executed by a processor implement the method according to claim 14.
